(19) United States
(12) Patent Application Publication
(10) Pub. No.: US 2025/0306914 A1
(43) Pub. Date: Oct. 2, 2025

(54) ORGANIZATIONAL AND ACCELERATED WRITER SYSTEM, SYSTEM AND METHODS FOR REPROGRAMMING

(71) Applicant: Matthew Honeycutt, Spring Hill, KS (US)

(72) Inventor: Matthew Honeycutt, Spring Hill, KS (US)

(21) Appl. No.: 19/093,338

(22) Filed: Mar. 28, 2025

Related U.S. Application Data
(60) Provisional application No. 63/571,521, filed on Mar. 29, 2024.

(51) Int. Cl. G06F 8/658; G06F 8/71

(52) U.S. Cl. CPC G06F 8/658; G06F 8/71

(57) ABSTRACT

An organizational and accelerated writer system, process, and method of use, a system and methods for reprogramming an electronic control module are presented. The proposed systems and methods leverage electronic module bootloaders and/or operating systems to obtain checksums and/or cyclic redundancy checks of each segment of an electronic module. The disclosed systems and methods reduce duration and improve upon the state of the art of electronic module firmware uploading and/or updating by comparing checksums of each flash segment's calculated value with a pre-established reference value.

### CROSS-REFERENCE TO RELATED APPLICATIONS

The present application claims priority to the U.S. Provisional Patent Application No. 63/571,521 which was filed on Mar. 29, 2024, which is hereby incorporated by reference herein in its entirety, including any figures, tables, or drawings.

### FIELD OF THE INVENTION

This disclosure relates to an organizational and accelerated writer system, process, and method of use, a system and methods for reprogramming an electronic control unit (or module). More specifically, and without limitation, the present disclosure relates to a system and method for reprogramming blocks of an electronic control unit.

### BACKGROUND OF THE INVENTION

Vehicles are well known in the art. Vehicles range in a wide variety from automobiles, well known in the art, to other and/or alternative vehicles such as tractors, airplanes, boats, motorcycles, bicycles, buses, wheelchairs, scooters, underwater vehicles, spacecraft, and the like.

Most vehicles have adopted onboard computing systems and technology. Even bicycles, which are historically powered by a person pedaling, have adopted electronic power and electronic power systems. It is estimated that even the simplest of motorized vehicles on the road today have over a million lines of code. These lines of code execute various functions for the vehicle. These functions may include sensing raindrops on a windshield, activating windshield wipers at a particular speed, sensing the stopping of rain, deactivating windshield wipers, power brakes, autonomous driving functionality, and many more functionalities and features. The overall control unit is the engine control unit while the various electronic control units may be considered various modules or blocks of the engine control unit overall.

These electronic features and functionalities of modern vehicles operate through an electronic control unit. Users often refer to this system as the brain of a vehicle. The system is an embedded system in vehicle electronics which control the electrical systems and electronic subsystems of a vehicle. The ECU can act as a controller for many systems, such as the powertrain module, the transmission module, and the like, also sometimes referred to as blocks of the ECU. Almost every system in a modern vehicle has an ECU which controls and/or incorporates control and function to the given vehicle portion or system. Some vehicles may also be considered to have hundreds of ECUs, also referred to as blocks.

The ECU of a vehicle includes many lines of code or software. The complexity of this software and code has increased substantially over recent years and has become a great challenge for manufacturers. Updating this software and sifting through millions of lines of code can be cumbersome, to say the least. Updating the software for security and other reasons needs to be done often for many reasons impacting the state of the art. However, updating can take a great deal of time, cause technical issues, and the like. Even small updates or changes require modified firmware which alter the functionality of a given ECU. Complicating matters further, various manufacturers each feature distinct firmware upload and/or updating processes.

In the current state of the art, a modified or updated firmware is typically transmitted to an ECU through a local interface. The existing state of the art solutions typically avoid going line by line and replace the entire ECU flash memory or a large portion thereof. This disregards any preexisting content.

Thus, there is a long-felt need in the art for an organizational and accelerated writer system, process, and method of use, a system and methods for reprogramming an electronic control unit which improves upon the state of the art and solves problems plaguing the state of the art of complex vehicle software updates and the like. Furthermore, a method which leverages functionalities inherent in the ECU's primary bootloader, secondary bootloader, and/or operating system to obtain a checksum and/or cyclic redundancy of each segment prior to, or during, the flash upload process would greatly improve on the present state of the art.

Thus, a system and/or method which significantly reduces the duration of ECU firmware updating as it compares to the checksum of each flash segment's calculated value with an ECU to a preestablished reference value, and only uploads those segments where the check sum does not match would provide a benefit to the state of the art, which is otherwise taught away from in the present delete and replace methodology of the art today.

The disclosure herein provides these advantages and others as will become clear from the specification and claims provided.

### SUMMARY OF THE INVENTION

Thus, it is a primary object of the disclosure to provide an organizational and accelerated writer system, process, and method of use, a system and methods for reprogramming an electronic control unit that improves upon the state of the art.

Another object of the disclosure is to provide an organizational and accelerated writer system, process, and method of use, a system and methods for reprogramming an electronic control unit that leverages functionalities inherent in the ECU(s) primary bootloader, secondary bootloader and/or operating system to obtain a checksum and/or cyclic redundancy check of each segment prior to, or during, the flash upload process.

Yet another object of the disclosure is to provide an organizational and accelerated writer system, process, and method of use, a system and methods for reprogramming an electronic control module which reduces the duration of ECU firmware upload as it compares the checksum of each flash segment's calculated value within the ECU to a reestablished reference value, and only uploads those segments where the checksum does not match.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a diagram illustrating the flash upload system and method, according to aspects of an embodiment of the disclosure.

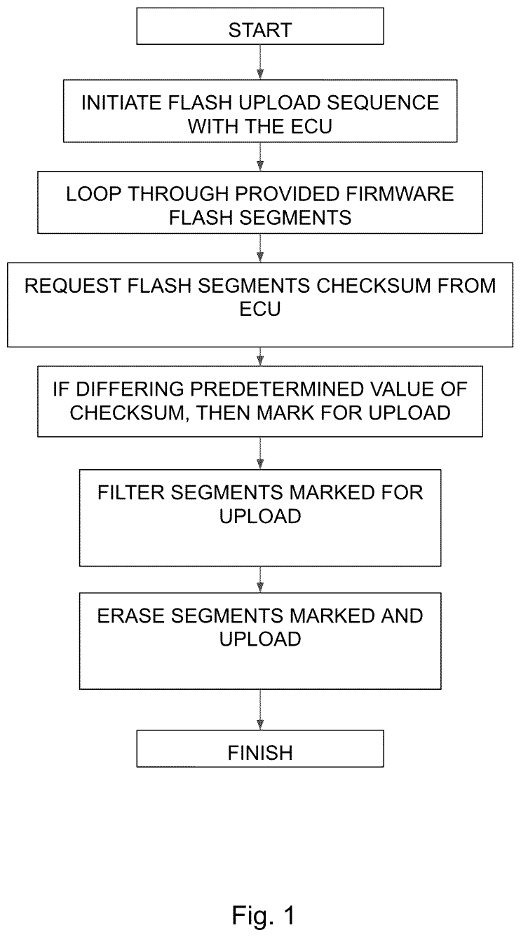

FIG. 2 is a diagram illustrating the flash upload system and method, according to aspects of an embodiment of the disclosure.

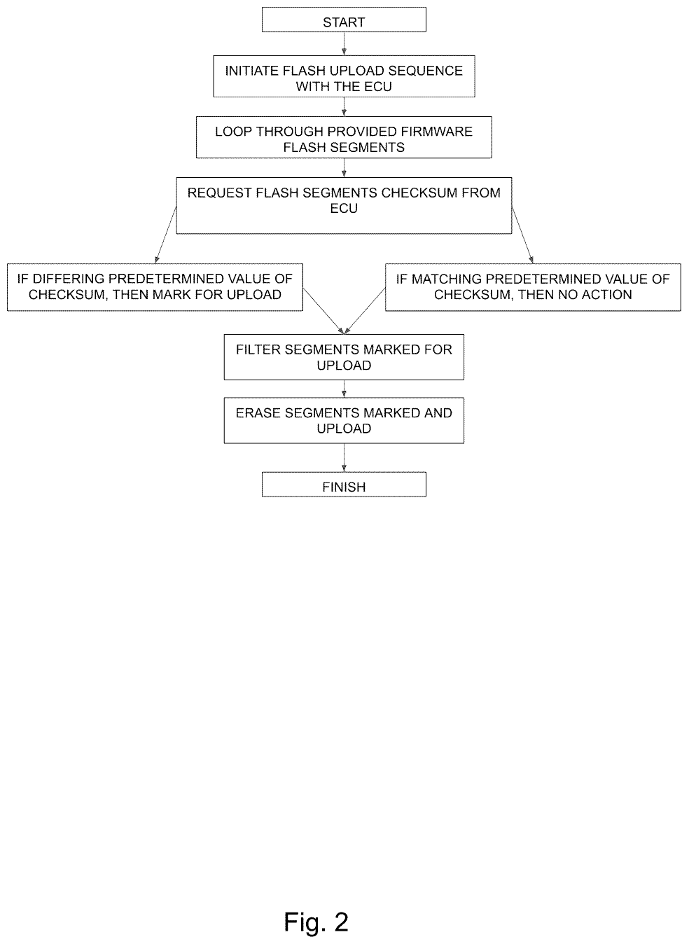

FIG. 3 is a diagram illustrating the flash upload system and method, according to aspects of an embodiment of the disclosure.

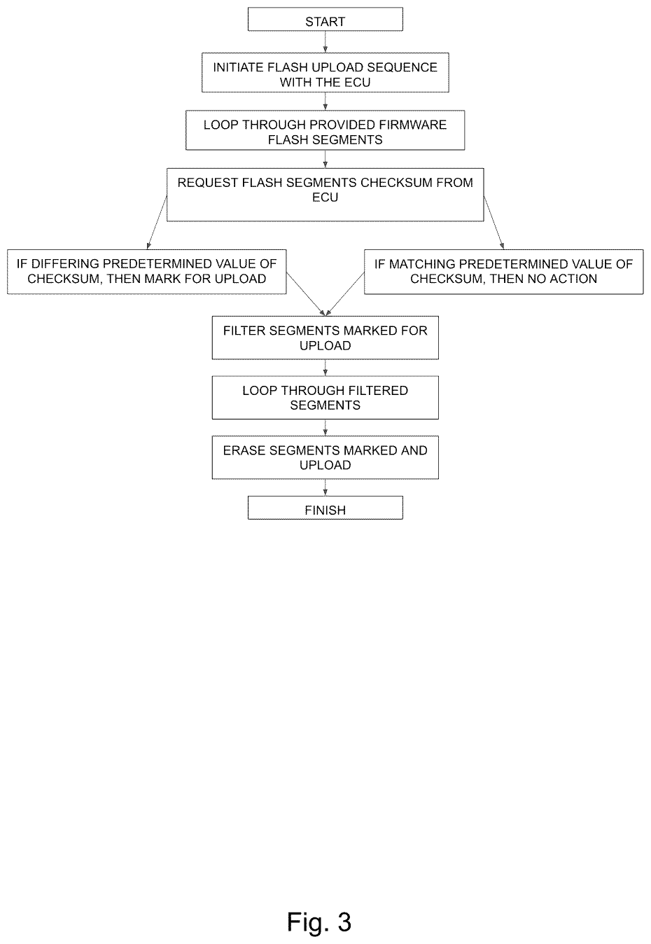

FIG. 4 is a diagram illustrating the flash upload system and method, according to aspects of an embodiment of the disclosure.

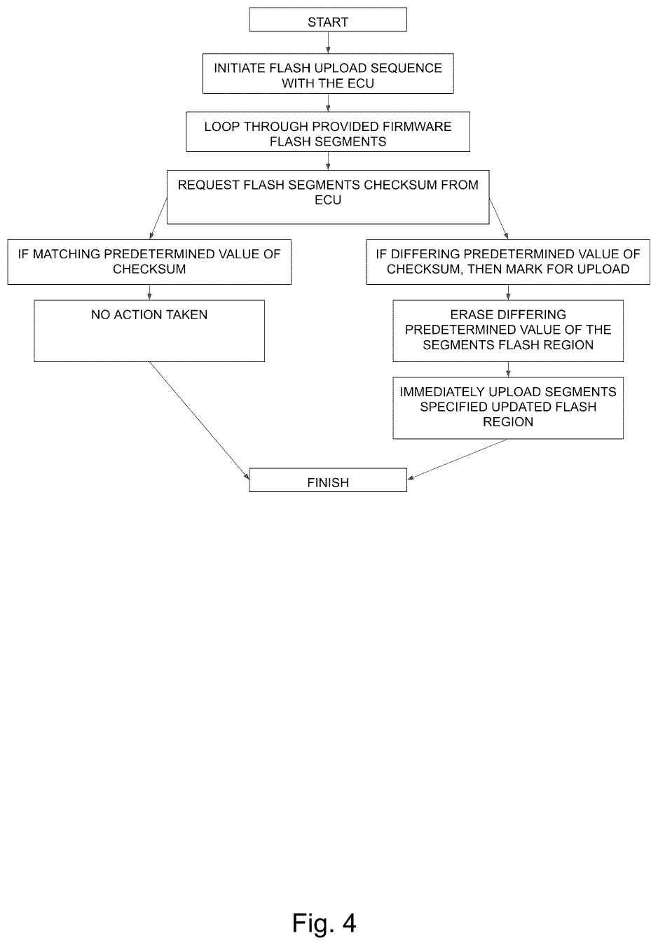

FIG. 5 is a diagram illustrating the flash upload system and method, according to aspects of an embodiment of the disclosure.

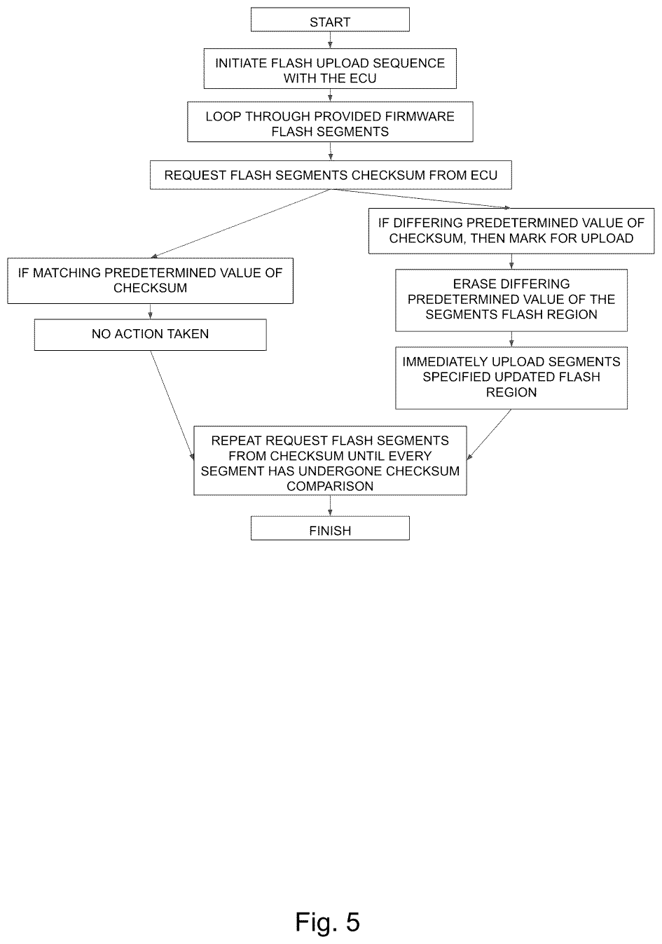

FIG. 6 is a diagram illustrating the flash upload system and method, according to aspects of an embodiment of the disclosure.

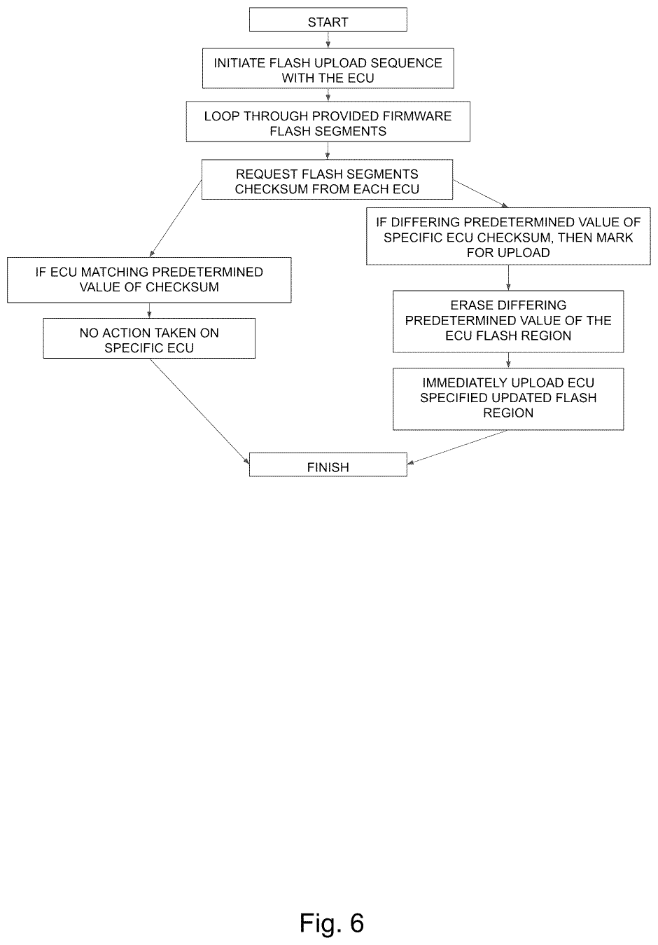

FIG. 7 is a diagram illustrating the flash upload system and method, according to aspects of an embodiment of the disclosure.

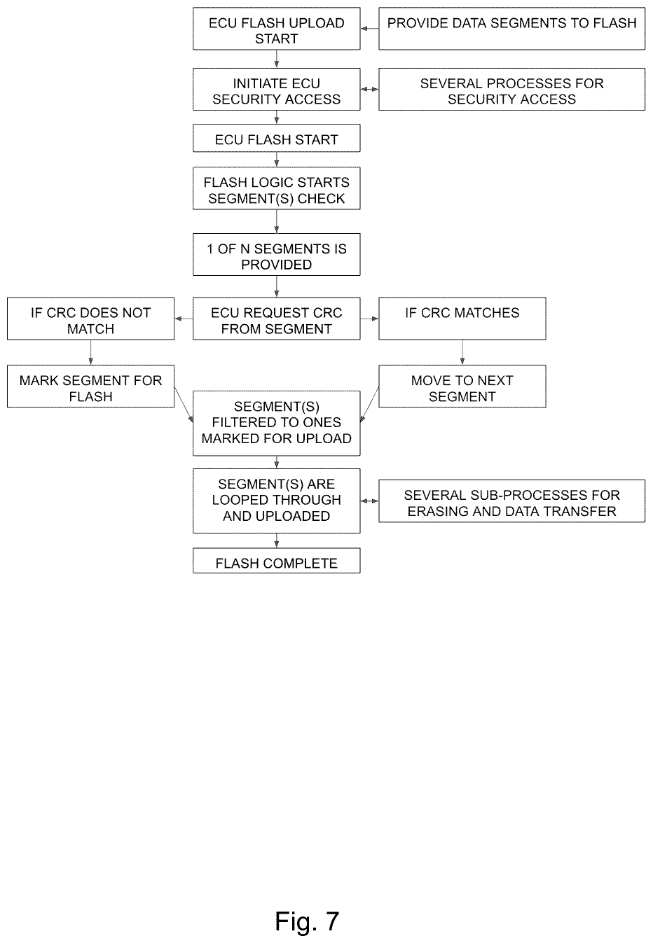

FIG. 8 is a diagram illustrating the flash upload system and method, according to aspects of an embodiment of the disclosure.

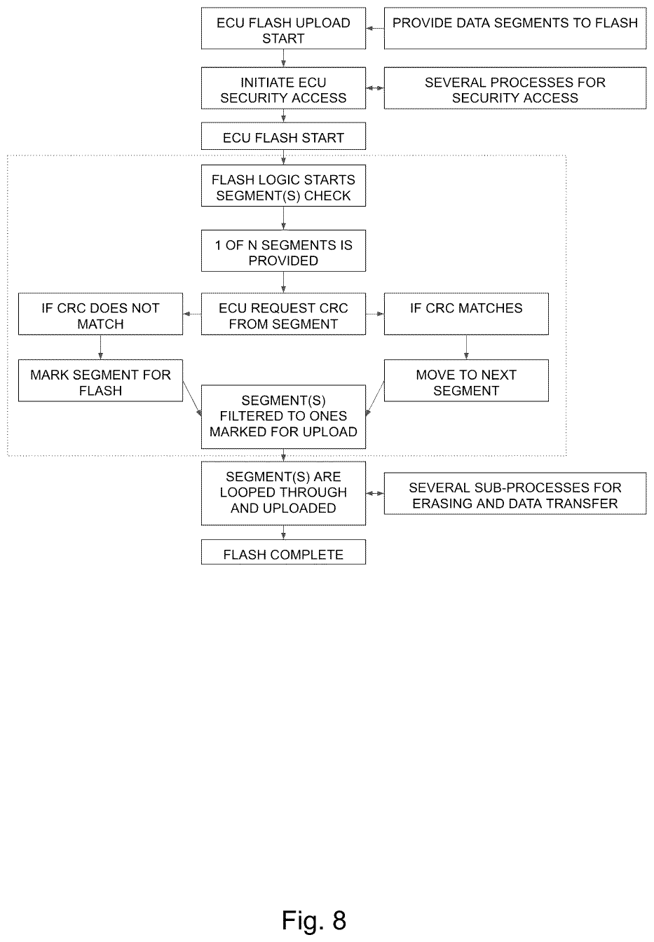

FIG. 9 is a diagram illustrating the flash upload system and method, according to aspects of an embodiment of the disclosure.

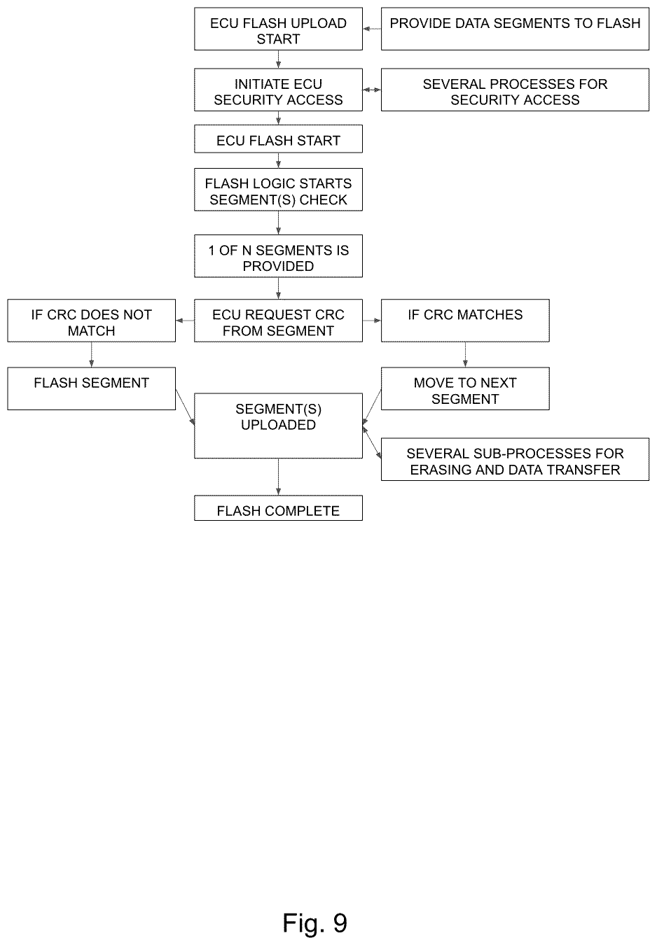

FIG. 10 is a diagram illustrating the flash upload system and method, according to aspects of an embodiment of the disclosure.

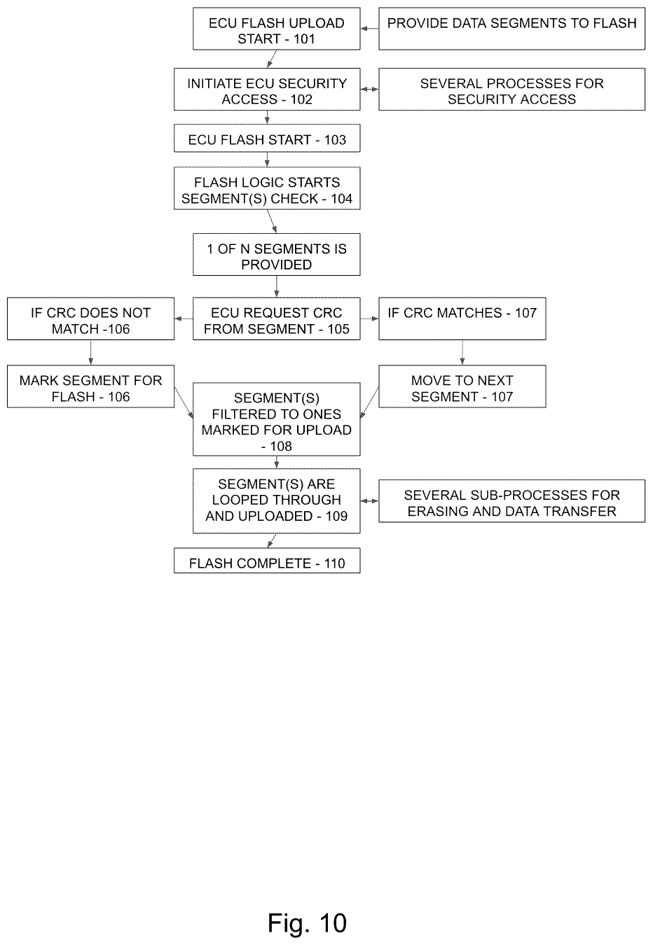

FIG. 11 is a diagram illustrating the flash upload system and method, according to aspects of an embodiment of the disclosure.

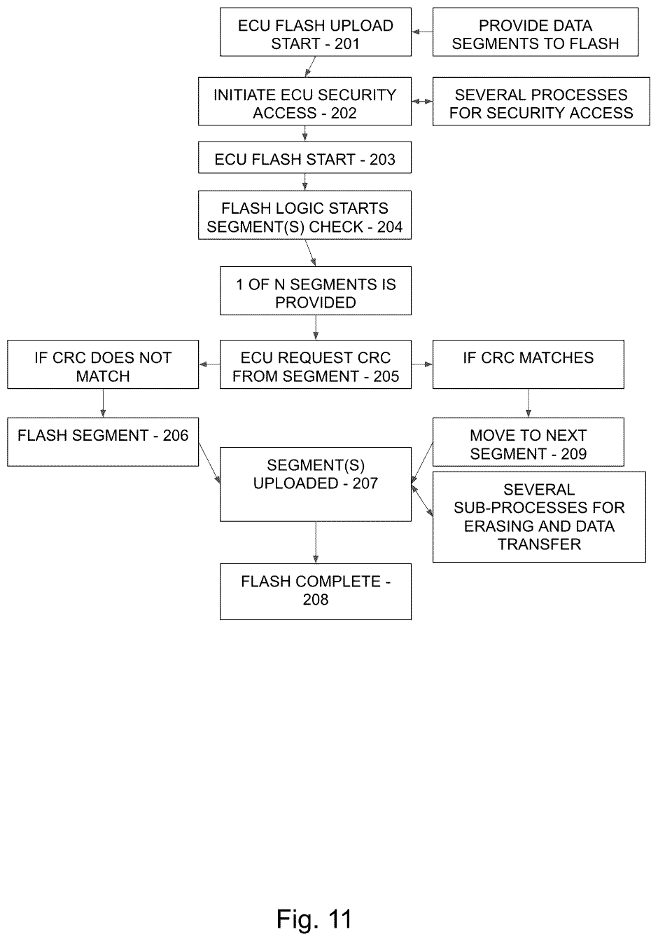

FIG. 12 is a diagram illustrating the arrangement of the system and interactions of various components of the platform with the flash system, according to aspects of an embodiment of the disclosure.

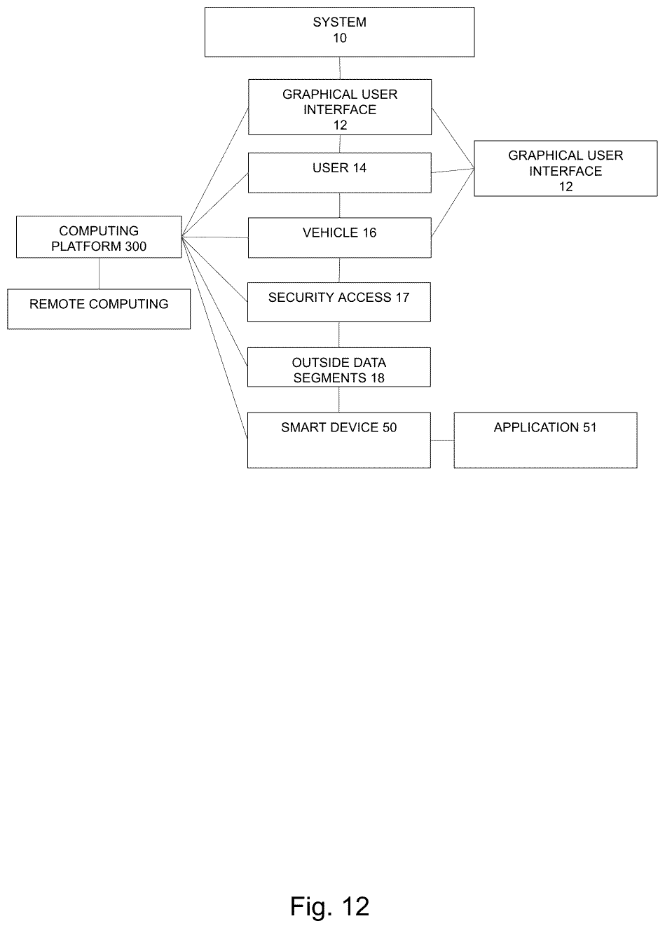

FIG. 13 is a diagram illustrating the arrangement of the engine control unit and interactions of various features of the flash system with the engine control unit, according to aspects of an embodiment of the disclosure.

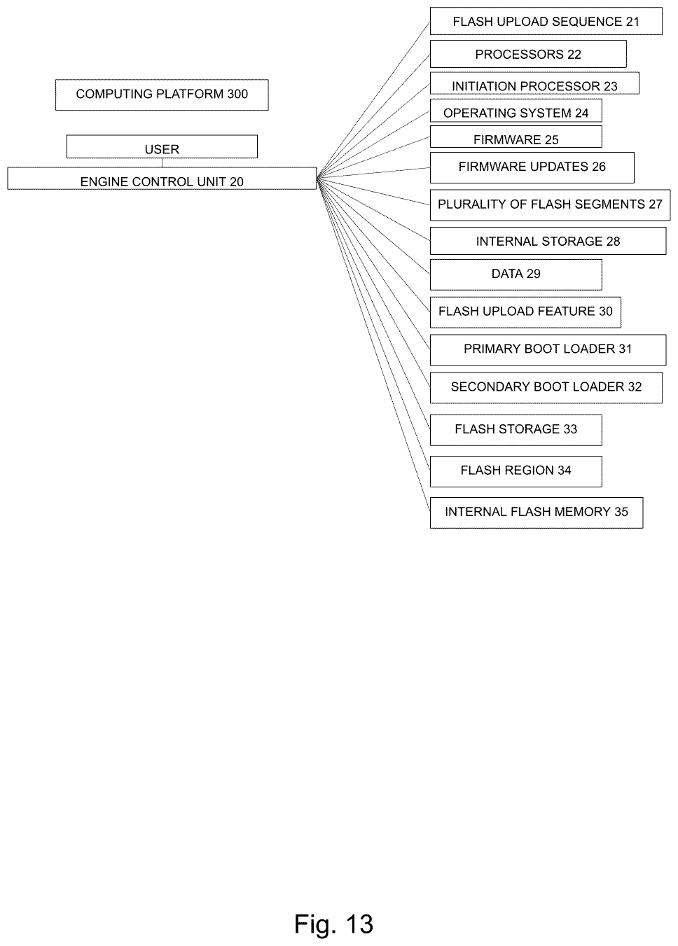

FIG. 14 is a diagram illustrating the arrangement of the system and interactions of various components of the system with the flash system, according to aspects of an embodiment of the disclosure.

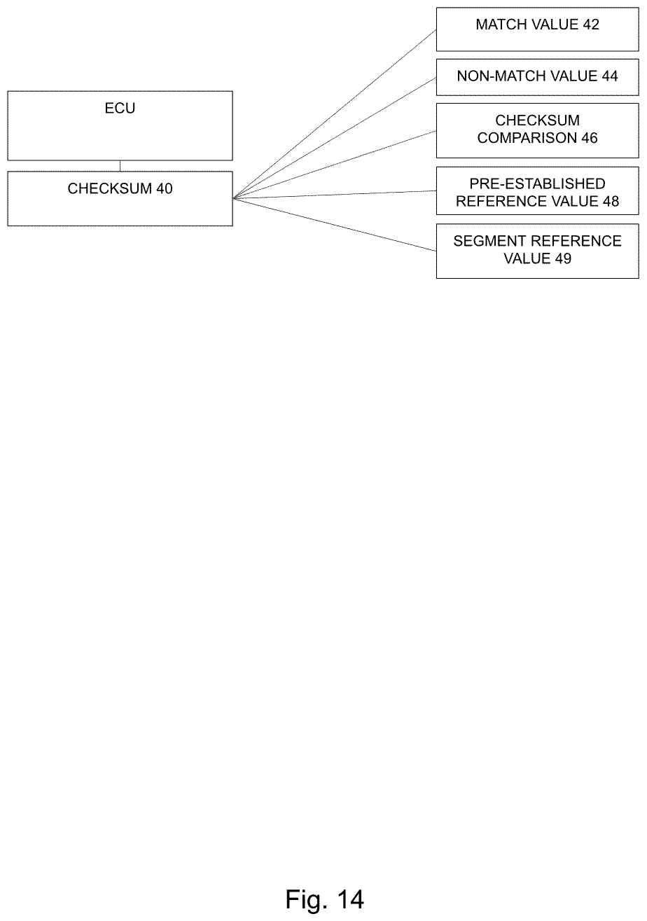

FIG. 15 is a diagram illustrating the arrangement of the system and interactions of various components, showing the filter, the writer, and the obtainer and some of those interactions with the flash system and the flash system components, according to aspects of an embodiment of the disclosure.

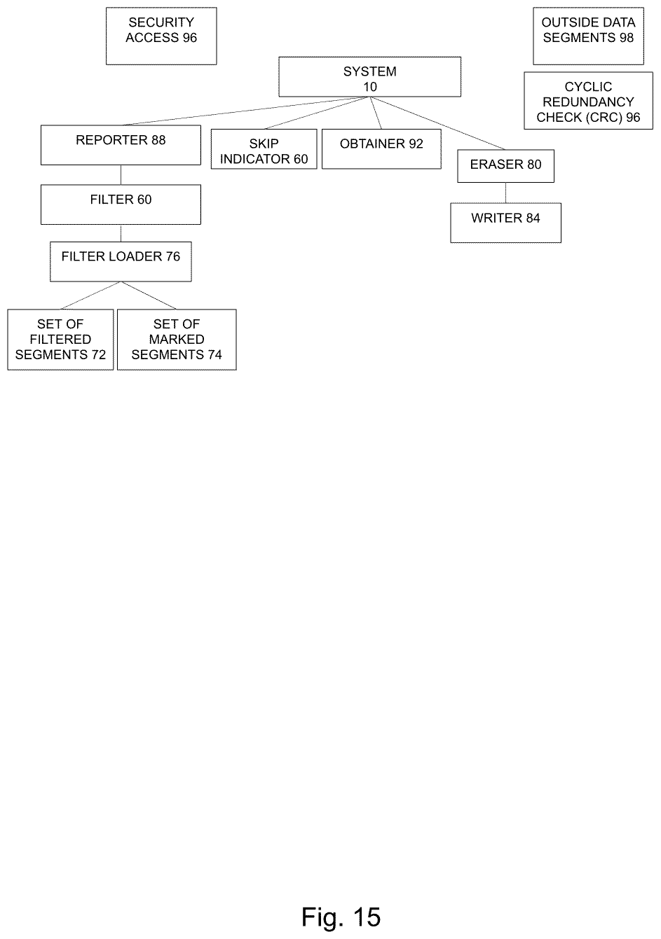

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed. Furthermore, the internal flash memory (further described herein) may include one or more of the following, but is not limited to, NOR, NAND, eMMC, Serial, FeRAM, and/or PCM.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

### System

With reference to the figures, an organizational and accelerated writer system, process, and method of use, a system and methods for reprogramming an electronic control module 10 are presented. an organizational and accelerated writer system, process, and method of use, a system and methods for reprogramming an electronic control module 10 (hereafter referred to as “reprogramming method”, “reprogramming system and method”, “upload system”, “update system”, or simply “system”) is formed of any suitable size, shape and design and is configured with all necessary steps, functionalities, and the like to commence upload procedures in various applications.

In the arrangement shown, as one example, system 10 may comprise remote servers, databases, application servers, application databases, product databases, mobile applications, and/or computers; all of which in continuity or as separate acts fulfill the functions disclosed herein. System 10 also includes, in the embodiment(s) depicted, a graphical user interface 12, a user 14, a vehicle 16, an electronic control module 17, an original equipment manufacturer (“OEM”) 18, an engine control unit (“ECU”) 20, a plurality of blocks 40, a filter 60, and a writer 70, among other components, features, and functions.

Furthermore, and in the arrangement shown, as one example, system 10 may include a core having a microcontroller, a memory of various types (see internal flash memory for further details herein), a plurality of inputs, a plurality of outputs, a plurality of communication features, existing software, new software, replacement software, and the like.

In the arrangement shown, as one example, the main structure of system 10 also includes a plurality of electronic control modules, a plurality of attachments, a plurality of wired connections, an onboard computing interface system, and communication and control components, among other components, features, and functionality.

Furthermore, in the arrangement shown, an automobile or car may often be referred to. This is for simplicity in explanation. An automobile or car is one example of a vehicle. The present disclosure should not be considered limiting to an automobile. Various vehicle types and the like are hereby contemplated for use. Furthermore, the present disclosure often uses the electronic module or electronic module unit of a vehicle. This is also for simplicity in explanation. The present disclosure is not only applicable to an engine control unit but can also be applied in other applications, as will become apparent herein.

### User (or Plurality Thereof)

In the arrangement shown, as one example, system 10 includes a user. User 14 may be any user interacting with or utilizing the system 10. This may include viewing, controlling, analyzing, manipulating, and/or interacting with system 10. User 14 is not limited to a single user but may be a plurality of users.

### User Interface

In the arrangement shown, as one example, system 10 may include a graphical user interface 12. Graphical user interface 12 is formed of any suitable size shape and design and is configured to allow a user to view interact with, manipulate, and visually access system data and information, information related thereto, and/or view various data for various vehicles and/or update and/or access to electronic control modules and blocks of electronic control modules and the firmware stored therein.

### Local Interface

In the embodiment shown, as one example, system 10 also includes a local interface 13 may be through direct interaction with the ECU and/or may be through an OBD2 (on-board diagnostics 2) connection or the like. An OBD2 connector, or standard 16-pin port, provides access to the onboard computing platform of the vehicle for providing diagnostics and/or potential programming/updating. The local interface 13 may also be via a bluetooth, wireless, ant or ant+ connection, near field control, a combination thereof, or the like.

### Vehicle

In the embodiment shown, as one example, system 10 includes a vehicle 16. Vehicle 16 is generally an automobile. Various vehicle types are hereby contemplated for use. A vehicle 16 may be any system which requires uploading and/or updating blocks and/or engine control units/modules.

### Engine Control Unit/Electronic Control Unit

In the embodiment shown, system 10 includes an electronic control unit 20. Various original equipment manufacturers produce and/or develop electronic control units which serve myriad purposes. One place electronic control units are found is in motor vehicles. Electronic control units feature distinct firmware, which is updated from time to time to suit various needs in the art.

In the examples and arrangements, “electronic control units”, “engine control units”, and “electronic module” are all terms used interchangeably and for ease of explanation. The disclosure presented and discussed herein should not be construed as limited to an engine control unit. The present disclosure could apply to any electronic module and should not be considered limited to just an engine control unit.

Almost all electronic control units require security access 17. Security access and protocols are contemplated herein and considered inherent in the upload and firmware update processes described herein.

In the embodiment disclosed herein, outside data segments 18 are provided. These outside data segments may also be referred to as updates or segments which are prepared outside and/or before the process disclosed herein.

In the embodiment shown, the electronic control unit can be accessed via a local interface 13. In the embodiment shown, the electronic control unit 20 may also include a flash upload sequence 21, a plurality of processors 22, an initiation processor 23, an operating system 24, a firmware 25, a firmware update 26 (or “modified firmware” or “frequent adjustments”) 26, a plurality of flash segments (or “segments”) 27, an internal storage 28, a data 29 (written to the internal storage 28), a flash upload feature 30, a primary boot loader 31, and a secondary boot loader 32, a flash storage 33, a flash region 34, and an internal flash memory 35, among other features and components.

### Segment

In the embodiment shown, as one example, system 10 includes a plurality of segments (or “blocks”, or “segments”, or “segment”) 27. Segments 27 may be formed of an array of data that represents a block of corresponding data in the ECU. Segments may be formed with a start address, a length, and CRC. A typical ECU has many Segments, the length and number of segments vary by manufacturer. A typical ECU is a firmware comprised of a number of blocks each having a set of data 29 written to internal storage 28 of the ECU.

### Internal Flash Memory

In the arrangement shown, as one example, system 10 includes an internal flash memory 35. Internal flash memory 35 is formed of any suitable size, shape, and design, and may be configured as various types, including but not limited to, NOR, NAND, eMMC, Serial, FeRAM, and PCM, among other types of internal flash memory.

### Checksum

In the embodiment shown, as one example, the proposed methods and system 10 significantly improve upon the state of the art and the upload process by providing an system and methods for comparing the checksum of each flash segment's calculated value within the electronic control unit to a preestablished reference value 48. In this way, the system only uploads those segments for which the checksums differ. Said another way, the computed hash and cyclic redundancy check 96 are referred to as a checksum, for simplicity.

In the embodiment shown, the checksum 40 also includes a match value 42 which indicates that the checksum of the preestablished reference value matches the existing electronic control module value 49 or segment reference value 49.

### Smart Device

In the arrangement shown, as one example, system 10 may also include a smart device 50 (also referred to as “device”, “computer”, “laptop”, “smart phone”, or simply “device”). Smart device 50 is formed of any suitable size, shape, and design, and is configured to provide various interactions for a user and is typically a computer/laptop/or other device for accessing and interacting with the vehicle and the many electronic control modules of the vehicle. Smart device 50 also includes an application 51 for executing the system and methods described herein. Smart devices vary greatly in size, shape, and function. Some smart devices such as smart phones also provide phone services, texting, gps, and the like.

In the arrangement shown, system 10 also includes a skip indicator 60, a filter 70, an eraser 80, a writer 84, a report 88, an obtainer 92, and a cyclic redundancy check 96.

Skip Indicator: In the embodiment of the present disclosure, the skip indicator 60 provides for marking the segments which can be skipped during the looping process. These segments which are marked for skipping have preestablished reference values which match the segment reference values. When these values match, the skip indicator will mark this flash region 34 for skipping and the flash upload sequence 21 will not upload and/or update this segment but will skip to the next and/or subsequent segment.

Filter: In the embodiment shown, as one example, the filter 70 marks segments which can be skipped and/or those which need updated. The filter 70 creates a set of filtered segments 72 in one embodiment. The filter 70 creates a set of marked segments 74 in another example. The filter loader 76 provides for lining up the list which needs to be addressed/uploaded/revised.

Eraser: In the embodiment shown, as one example, the eraser 80 erases segments which have been marked for updating. Once erased the segment can be updated.

Writer: In the embodiment shown, as one example, the writer 84 writes or uploads the new firmware/replacement updates which are to be uploaded and/or firmware updates/frequent adjustments to each of the plurality of flash segments 27.

Reporter: In the arrangement shown, as one example, system 10 includes a reporter 88. The reporter 88 reports or provides the list of each checksum which has a match value or a non-match value with regards and respect to the preestablished reference value and the segment reference value.

Obtainer: In the arrangement shown, as one example, system 10 includes an obtainer 92. The obtainer 92 marks or provides indications on each of the plurality of segments which has been listed by the reporter 88 as having a match value or a non-match value with regards and respect to the preestablished reference value and the segment reference value.

Cyclic Redundancy Check: In the arrangement shown, as one example, system 10 includes a cyclic redundancy check 96. Cyclic redundancy check is another term used herein to describe how the checksum value is obtained and/or how the values are compared in each segment prior to, or during, the flash upload process.

### Operation/Method

In the arrangement shown, as one example, system 10 is configured to significantly reduce the duration of time and strain on systems required for an ECU firmware upload. In this operation/method, as one example, the local device initiates a flash upload sequence with the engine control unit.

Said another way, the upload is started. As part of this step, the security systems of the ECU are accessed along with several subprocesses for this purpose. Once the ECU is correctly accessed, the flash upload starts. Once accessed, the local device executes loop(s) through the provided firmware flash segments. The segment is an array of data that represents a block of corresponding data in the ECU. The segment includes a start address, a length, and a CRC, among other features. Depending on the manufacturer and/or circumstances, an ECU may include many segments (or 1 . . . n blocks (segments) of data).

As part of the loop, each flash segments checksum is requested from the ECU. Said another way, the CRC for the segment is requested from the ECU. If the CRC matches the request, then the system moves to the next segment. If the CRC does not match the request, then the CRC marks the non-matching segment for flash. Said another way, if the checksum reported by the ECU does not match the predetermined value for the segment, then it is marked to be uploaded to the ECU.

Said another way, if the checksum reported by the ECU does match the predetermined value for the segment, then it moves to the next segment with no action. Then, the local device filter feature filters through the segments to the segments marked for upload. The local device then loops through the filtered segments.

Said another way, the filtered segments are looped through and uploads completed until no more segments are not matched. This process of looping includes several sub-processes that occur to flash a segment such as erasing, and data transfer. The segments flash region on the ECU is then erased and then uploaded. The flash is then complete.

Said another way, method 1 includes the following steps: 1) the local device initiates a flash upload sequence with the ECU—with reference to step 101, 102, 103. 2) The local device will loop through provided firmware flash segments—with reference to step 104. 2a) Each flash segments checksum is then requested from the ECU—with reference to step 105. 2b) If the checksum reported by the ECU does not match the predetermined value for the segment, it is then marked to be uploaded to the ECU—with reference to step 106. 2c) If the checksum reported by the ECU does match the predetermined value for the segment, it then moves to the next segment with no action—with reference to step 107. 3) The local device filters the segments to the ones marked for upload—with reference to step 108. 3a) The local device then loops through the filtered segments—with reference to step 109. 3b) The segments flash region on the ECU is erased, and then uploaded—with reference to step 109. 4) Flash complete—with reference to step 110.

### Alternative Embodiment Operation/Method

In the arrangement shown, as one example, system 10 is configured to significantly reduce the duration of time and strain on systems required for an ECU firmware upload. In this operation/method, as one example, the local device initiates a flash upload sequence with the ECU. Said another way, the upload is started. As part of this step, the security systems of the ECU are accessed along with several subprocesses for this purpose.

Once the ECU is correctly accessed, the flash upload starts. Once accessed, the local device executes loop(s) through the provided firmware flash segments. The segment is an array of data that represents a block of corresponding data in the ECU. The segment includes a start address, a length, and a CRC, among other features.

Depending on the manufacturer and/or circumstances, an ECU may include many segments (or 1 . . . n blocks (segments) of data). As part of the loop, each flash segments checksum is requested from the ECU. Said another way, the CRC for the segment is requested from the ECU. Said another way, if the checksum reported by the ECU does match the predetermined value for the segment, then it moves to the next segment with no action. If the CRC matches the request, then the system moves to the next segment. If the CRC does not match the request, then the ECU is requested to erase the segments flash region. The segment is then immediately uploaded to the segments specified in the flash region. The process repeats until every segment has undergone checksum comparison and, if necessary, uploaded to the ECU. The flash upload is then complete.

Said another way, method 2 includes the following steps: 1) The local device initiates a flash upload sequence with the ECU—with reference to step 201, 202, 203. 2) The local device loops through all provided flash segments—with reference to step 204. 2) Each flash segments checksum is then requested from the ECU—with reference to step 205. 2b) If the checksum reported by the ECU does not match the predetermined value for that segment—with reference to step 206. 2bi) The ECU is requested to erase that segments flash region—with reference to step 207. 2bii) The segment is then immediately uploaded to the segments specified flash region—with reference to step 207. 2c) If the checksum reported by the ECU does match the predetermined value for that segment no action is taken—with reference to step 209. 2d) This process repeats until every segment has undergone checksum comparison and, if necessary, uploaded to the ECU—with reference to step 210. 3) Flash upload is then complete—with reference to step 208.

### Alternative Embodiment Operation/Method

In the arrangement shown, as one example, system 10 is configured to significantly reduce the duration of time and strain on systems required for an electronic module firmware update. In this operation/method, as one example, the local device initiates a flash upload sequence with the electronic module. Said another way, the upload is started. As part of this step, the security systems of the electronic module are accessed along with several subprocesses for this purpose.

Once the electronic module is correctly accessed, the flash upload starts. Once accessed, the local device executes loop(s) through the provided firmware flash segments. The segment is an array of data that represents a block of corresponding data in the electronic module. The segment includes a start address, a length, and a cyclic redundancy check.

Depending on the manufacturer and/or circumstances, an electronic module may include a plurality of segments or many segments forming a single module of a plurality of electronic modules. As part of the loop, a checksum for each of the plurality of modules is requested from the electronic module. This may be a plurality of electronic modules, each having a plurality of segments and a plurality of associated checksums.

Said another way, the cyclic redundancy check for each of the plurality of segments is requested from the electronic module. If the checksum reported by the electronic module does match the predetermined value for the associated segment, meaning that the predetermined value or value in that matching segment for the firmware update is a match for the value of the associated existing segment, then it moves to the next segment with no action. If the CRC matches the request, then the system moves to the next segment.

If the CRC does not match the request, meaning that the predetermined value or value in that matching segment for the firmware update is a non-match for the value of the associated existing segment, then the electronic module is requested to erase the segments flash region. The segment is then immediately uploaded to the segments specified in the flash region. The process repeats until every segment has undergone checksum comparison and, if necessary, uploaded to the electronic module. The flash upload is then complete.

Said another way, alternative method includes the following steps: 1) The local device initiates a flash upload sequence with the electronic module—with reference to step 201, 202, 203. 2) The local device loops through all provided flash segments—with reference to step 204. 2) Each flash segment's checksum is then requested from the electronic module—with reference to step 205. 2b) If the checksum reported by the electronic module does not match the predetermined value for that segment—with reference to step 206. 2bi) The electronic module is requested to erase that segments flash region—with reference to step 207. 2bii) The segment is then immediately uploaded to the segments specified flash region—with reference to step 207. 2c) If the checksum reported by the electronic module does match the predetermined value for that segment no action is taken—with reference to step 209. 2d) This process repeats until every segment has undergone checksum comparison and, if necessary, uploaded to the electronic module—with reference to step 210. 3) Flash upload is then complete—with reference to step 208.

### Computing Platform

In the arrangement shown, as one example, system 10 includes a computing platform 300 (or “computer”, or “computer platform”). Computing platform 300 is formed of any suitable size, shape, and design and is configured to provide computing support, power, and computing processing for both onboard computing functionality as well as communication for off-board or server computing functionality. In this way, an onboard computing system, among other components and features on top of the platform.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A system for reprogramming an electronic control unit, comprising:
initiating a flash upload sequence of an electronic control unit, by one or more processors comprising an initiation processor from an application of a smart device of a user,
looping through flash segments of a firmware of an operating system of a local interface of the electronic control unit;
requesting each checksum of each flash segment;
reporting each checksum a match value or a non-match value, via a reporter, by one or more processors;
marking each checksum with a non-match value of each flash segment for flash upload, via an obtainer, by one or more processors;
marking each checksum with a match value of each flash segment for skipping, via a skip indicator, by one or more processors;
filtering the checksums with a non-match value for flash upload to a set of filtered segments;
looping through the set of filtered segments;
erasing each of the set of filtered segments, via an eraser;
uploading an associated flash segment for each respective flash segment of the set of filtered segments, via a writer;
completing flash upload.

2. The system of claim 1, further comprising:
a vehicle;
the vehicle having an electronic control unit;
the electronic control unit having a firmware comprised of a plurality of segments;
each of the plurality of segments formed of data written to an internal storage;
a firmware update, wherein the firmware update is formed of a modified firmware, said
modified firmware transmitted to the electronic control unit through a local interface;
the electronic control unit having a local interface;
the electronic control unit having a primary boot loader;
the electronic control unit having a secondary boot loader;
the electronic control unit having an operating system;
the electronic control unit having a firmware;
the electronic control unit having a plurality of flash segments of the firmware;
a plurality of firmware updates, wherein the firmware updates are updates from outside of the electronic control unit which are configured to provide updates to the electronic control unit;
the electronic control unit having a flash region;
providing a graphical user interface, wherein the graphical user interface is the graphical user interface of a smart device;
providing a local interface, wherein the local interface is the interface of the vehicle.

3. The system of claim 1, further comprising:
leveraging functionalities inherent in a primary boot loader of the electronic control unit to obtain the checksum of each segment prior to the flash upload;
leveraging functionalities inherent in a secondary boot loader of the electronic control unit to obtain the checksum of each segment prior to the flash upload;
leveraging functionalities inherent in an operating of the electronic control unit to obtain the checksum of each segment prior to the flash upload;
considering pre-existing content of each of the segments.

4. The system of claim 1, further comprising:
a firmware update, wherein the firmware update is formed of a modified firmware, said modified firmware transmitted to the electronic control unit through a local interface;
the electronic control unit having a local interface;
the electronic control unit having a primary boot loader;
the electronic control unit having a secondary boot loader;
the electronic control unit having an operating system;
the electronic control unit having a firmware;
the electronic control unit having a plurality of flash segments of the firmware;
a plurality of firmware updates, wherein the firmware updates are updates from outside of the electronic control unit which are configured to provide updates to the electronic control unit;
the electronic control unit having a flash region.

5. A method to obtain a checksum during a flash upload process of an electronic control unit, comprising the steps:
initiating a flash upload sequence of an electronic control unit, by one or more processors comprising an initiation processor from an application of a smart device of a user,
looping through flash segments of a firmware of an operating system of a local interface of the electronic control unit;
requesting each checksum of each flash segment;
reporting each checksum a match value or a non-match value, via a reporter, by one or more processors;
marking each checksum with a non-match value of each flash segment for flash upload, via an obtainer, by one or more processors;
marking each checksum with a match value of each flash segment for skipping, via a skip indicator, by one or more processors;
filtering the checksums with a non-match value for flash upload to a set of filtered segments;
looping through the set of filtered segments;
erasing each of the set of filtered segments, via an eraser;
uploading an associated flash segment for each respective flash segment of the set of filtered segments, via a writer;
completing flash upload.

6. The method of claim 5, further comprising the steps:
providing a vehicle; the vehicle having an electronic control unit; the electronic control unit having a firmware comprised of a plurality of segments; each of the plurality of segments formed of data written to an internal storage; the electronic control unit having a local interface; the electronic control unit having a primary boot loader; the electronic control unit having a secondary boot loader; the electronic control unit having an operating system; the electronic control unit having a firmware; the electronic control unit having a plurality of flash segments of the firmware; the electronic control unit having a flash region;
providing a firmware update, wherein the firmware update is formed of a modified firmware, said modified firmware transmitted to the electronic control unit through a local interface;
providing a plurality of firmware updates, wherein the firmware updates are updated segments from outside of the electronic control unit which are configured to provide updates to the electronic control unit;
providing a graphical user interface, wherein the graphical user interface is the graphical user interface of a smart device;
providing a local interface, wherein the local interface is the interface of the vehicle.

7. The method of claim 5, further comprising the steps:
providing an internal flash memory.

8. The method of claim 5, further comprising the steps:
providing a graphical user interface;
providing a local interface.

9. The method of claim 5, further comprising the steps:
accessing the local interface of a vehicle, the vehicle being an automobile.

10. The method of claim 5, further comprising the steps:
providing the electronic control unit with a number of blocks, each having a set of data written to an internal storage of the electronic control unit, wherein a segment is an array of data that represents a block of corresponding data in the electronic control unit; the segment having a start address; the segment having a length; the segment having a cyclic redundancy check.

11. The method of claim 5, further comprising:
a primary boot loader;
a secondary boot loader;
an operating system.

12. The method of claim 5, further comprising:
the electronic control unit having a local interface; the electronic control unit having a primary boot loader; the electronic control unit having a secondary boot loader; the electronic control unit having an operating system; the electronic control unit having a firmware; the electronic control unit having a plurality of flash segments of the firmware;
a plurality of firmware updates, wherein the firmware updates are updates from outside of the electronic control unit which are configured to provide updates to the electronic control unit;
the electronic control unit having a flash region, wherein the flash region consists of a length of code; the electronic control unit having an internal storage, wherein data is written to the internal storage; the electronic control unit having a flash storage; the electronic control unit having an internal flash memory.

13. The method of claim 5, further comprising the steps:
initiating electronic control unit flash upload start;
requesting security access to the electronic control unit;
initiating a set of sub-processes for security access to the electronic control unit;
starting the flash of the electronic control unit, wherein starting the flash is initiating the method to obtain the checksum during the flash upload process of the electronic control unit.

14. The method of claim 5, further comprising the steps:
looping through segments;
executing a set of subprocesses of the segment flash process, wherein the sub-processes comprise erasing the segment, transferring data of a replacement segment, writing the data of the replacement segment to the flash segment;
looping through the segments to verify no additional non-match values are identified.

15. The method of claim 5, further comprising the steps:
providing a smart device, the smart device having an application for accessing a local interface of a vehicle.

16. A method of organizing blocks of an electronic control module, comprising the steps:
initiating a flash upload sequence of an electronic control module, by one or more processors comprising an initiation processor from an application of a smart device of a user,
looping through all flash segments of an operating system of the electronic control unit;
requesting a checksum of each flash segment;
reporting each checksum a match value or a non-match value, via a reporter, by one or more processors;
marking each checksum with a non-match value of each flash segment for flash upload, via an obtainer, by one or more processors;
erasing each of the non-match value marked checksum flash segments, via an eraser;
uploading, immediately, an associated flash segment for each respective flash segment of the set of marked segments, via a writer;
looping through each flash segment until each flash segment has undergone a checksum comparison and upload thereof;
completing flash upload.

17. The method of claim 16, further comprising the steps:
executing a set of subprocesses of the segment flash process, wherein the sub-processes comprise erasing the segment, transferring data of a replacement segment, writing the data of the replacement segment to the flash segment.

18. The method of claim 16, further comprising the steps:
executing a set of subprocesses of the segment flash process, wherein the sub-processes comprise erasing the segment, transferring data of a replacement segment, writing the data of the replacement segment to the flash segment;
looping through the segments to verify no additional non-match values are identified;
repeating the looping through process until every segment has undergone checksum comparison, wherein if necessary, meaning non-match values identified by the filter, then the replacement segment is uploaded to the electronic control unit.

19. The method of claim 16, further comprising the steps:
providing a vehicle; the vehicle having an electronic control unit; the electronic control unit having a firmware comprised of a plurality of segments; each of the plurality of segments formed of data written to an internal storage; the electronic control unit having a local interface; the electronic control unit having a primary boot loader; the electronic control unit having a secondary boot loader; the electronic control unit having an operating system; the electronic control unit having a firmware; the electronic control unit having a plurality of flash segments of the firmware; the electronic control unit having a flash region;
providing a firmware update, wherein the firmware update is formed of a modified firmware, said modified firmware transmitted to the electronic control unit through a local interface;
providing a plurality of firmware updates, wherein the firmware updates are updated segments from outside of the electronic control unit which are configured to provide updates to the electronic control unit;
providing a graphical user interface, wherein the graphical user interface is the graphical user interface of a smart device;
providing a local interface, wherein the local interface is the interface of the vehicle.
